(19) United States
(12) Patent Application Publication
(10) Pub. No.: US 2015/0264784 A1
(43) Pub. Date: Sep. 17, 2015

(54) WIRELESS READY LIGHTING DRIVER

(71) Applicant: Shafrir ROMANO, Rishon Letzion (IL)

(72) Inventor: Shafrir ROMANO, Rishon Letzion (IL)

(21) Appl. No.: 14/658,258

(22) Filed: Mar. 16, 2015

Related U.S. Application Data
(60) Provisional application No. 61/953,952, filed on Mar. 17, 2014.

(51) Int. Cl. H05B 37/02; H05B 33/08

(52) U.S. Cl. CPC H05B 37/0272; H05B 33/0854; H05B 33/0872

(57) ABSTRACT

A method, apparatus and system for controlling a lighting driver are provided, wherein a lighting driver comprises a driving unit configured to receive AC power through an AC power line, a control unit coupled to the driving unit and configured to affect one or more operating parameters of the driving unit, and an interface port coupled to the control unit and adapted to accept a wireless adapter, thereby allowing remote control of the driving unit operation through the wireless adapter and the control unit.

### FIELD OF THE INVENTION

The present invention relates generally to lighting systems, and more particularly to methods and systems of controlled lighting.

### BACKGROUND OF THE INVENTION

Light Emitting Diodes (LED)s have become a prevailing technology in the industry of lighting. Various methods for controlling LED lighting are described in the art. Exemplary references include copending U.S. patent application Ser. No. 61/807,339, which discloses techniques that help to provide efficient LED lighting in a given space. This is achieved by controlling various LED driving parameters based on a variety of control sources. These sources include sensors of various environmental parameters such as lighting level and motion in the lighting area. The later patent application also discloses a LED driver comprising a wireless interface for communicating with a remote controller.

However, it would be desirable to achieve a low-cost lighting driver, in particular a LED driver, which can be easily upgraded to be remote controllable.

### SUMMARY OF THE INVENTION

Accordingly, it is a principal object of the present invention to provide improved methods and systems comprising a lighting driver, wherein the lighting driver is adapted to accept a pluggable wireless adapter. Thus, in accordance with an embodiment of the present invention, there is provided a lighting driver which comprises a driving unit configured to receive AC power through an AC power line, a control unit coupled to the driving unit and configured to affect one or more operating parameters of the driving unit, and an interface port coupled to the control unit and adapted to accept a wireless adapter, thereby allowing remote control of the driving unit operation through the wireless adapter and the control unit.

In an embodiment, the remote control of the driving unit operation comprises messages that the wireless adapter transfers to the control unit. In an alternative embodiment, the remote control comprises electrical levels that the wireless adapter transfers to the control unit.

In an embodiment, the control unit is further configured to manage the wireless adapter. The control unit is further configured, upon receiving AC power through a phase cut dimmer, to control the driving unit responsively to the phase cut dimmer dimming angle.

In an embodiment, LED lighting is used, and the interface port comprises Universal Serial Bus (USB).

In some embodiments, the one or more lighting parameters comprise at least one of lighting intensity, lighting color and lighting blinking rate, and the remote control thereof comprises monitoring as well as command.

In some embodiments, the wireless adapter supports at least one of Bluetooth, ZigBee and Wi-Fi wireless protocols.

In an embodiment, the remote control of the driving unit operation comprises a control application installed in a remote controller, which may be, in some embodiments a smartphone.

In some embodiments, the remote control of the driving unit operation comprises data communication between environmental sensors and the wireless adapter.

In accordance with an embodiment of the present invention, there is also provided a method comprising the step of providing a lighting driver that comprises an interface port adapted to accept a wireless adapter, thereby allowing wireless remote control of the lighting driver when there is a wireless adapter plugged into the interface port.

In accordance with an embodiment of the present invention, there is further provided a lighting system comprising a lighting driver and a wireless adapter, wherein the lighting driver comprises an interface port into which the wireless adapter is plugged, thereby allowing wireless remote control of the lighting driver.

### BRIEF DESCRIPTION OF THE DRAWINGS

The present invention will be more fully understood from the following detailed description of the embodiments thereof, taken together with the drawings in which:

FIG. 1 is a block diagram that schematically illustrates a lighting system comprising a lighting driver, in accordance with an embodiment of the present invention; and

FIG. 2 is a flowchart that schematically illustrates a method for controlling a lighting driver, in accordance with an embodiment of the present invention.

### DETAILED DESCRIPTION OF EMBODIMENTS

Embodiments of the present invention provide low cost lighting systems based on a lighting driver, typically a LED driver, which comprises an interface port. Once a need arises to control the lighting parameters of such a lighting driver remotely, a wireless adapter may be plugged into its interface port. The lighting driver is then controllable by any suitable remote control means.

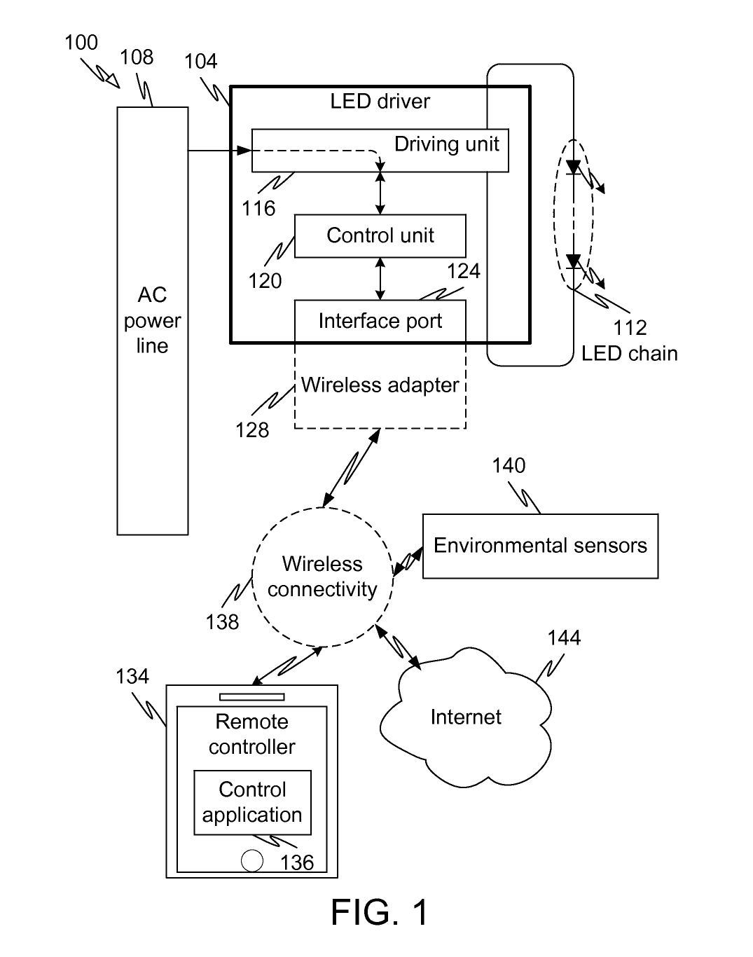

Referring to FIG. 1, there is shown a block diagram of a lighting system 100, in accordance with an embodiment of the present invention. In the figure, there is shown a LED driver 104, connected to an AC power line 108. LED driver 104 drives a LED chain 112. Inside LED driver 104, there is shown a driving unit 116 which is fed from AC power line 108.

A control unit 120, typically Pulse Width Modulation (PWM) based, controls driving unit 116. In an embodiment, control unit 120 may affect various operating parameters of driving unit 116 such as lighting intensity/dimness, lighting color/temperature and lighting blinking rate. In an embodiment, control unit 120 also constantly senses whether the AC power received from AC power line 108 is affected by a phase cut dimmer, and detects the dimming angle in this case. This is depicted in FIG. 1 by a dashed line through driving unit 116. Control unit 120 then affects, through driving unit 116, the lighting intensity of LED chain 112, respectively to the detected dimming angle. The term “control” stands hereinafter for “command” as well as for “monitoring”.

LED driver 104 also comprises an interface port 124, coupled to control unit 120 and adapted to accept a wireless adapter 128, thereby allowing remote control of driving unit 116 operating parameters through a wireless connectivity 138. In an embodiment, interface port 124 comprises Universal Serial Bus (USB) interface, however, in other embodiments, any other suitable interface may be used. In embodiments of the present invention, wireless adapter 128 may support various types of communication protocols such as Bluetooth, ZigBee and Wi-Fi. Wireless adapter 128 would typically feature a mini-card form, pluggable through an appropriate slot in LED driver 104.

In an embodiment, control unit 120 comprises a micro-processor which executes a program code that can manage wireless adapter 128, as well as interpret command and monitoring messages received from a remote location through wireless adapter 128. In an alternative embodiment, control unit 120 comprises a simple electronic circuit and needs wireless adapter 128 to convert between remote messages, at the wireless side of wireless adapter 128, and variable electrical levels at its controller side. In an embodiment, when the lighting intensity of LED driver 104 is remotely controlled while it is fed through a phase cut dimmer, control unit 120 would prioritize the remotely commanded lighting intensity, provided that it is not too high relative to the lighting intensity implied from the dimming angle.

In embodiments of the present invention, various remote control means may communicate with LED driver 104 through wireless adapter 128, when the adapter is plugged into interface port 124. Some of those remote control means are shown in FIG. 1 and described herein. A remote controller 134, which may be a dedicated appliance or a universal remote controller, communicates with LED driver 104 through wireless connectivity 138. Remote controller 134 may be, for example, a smartphone that runs a control application 136. Environmental sensors 140 may provide control application 136 and/or control unit 120, with environmental data such as lighting level and detected motion in the vicinity of LED chain 112. Control application 136 and/or control unit 120 may then affect the lighting parameters of driving unit 116 based on the environmental data. Other control means, not shown in FIG. 1, may communicate with any of the above described control means through the Internet, depicted as 144.

The above description has focused on the specific elements of lighting system 100 that are essential for understanding certain features of the disclosed techniques. Conventional elements the system not needed for this understanding have been omitted from FIG. 1 for the sake of simplicity, but will be apparent to persons of ordinary skill in the art. The configuration shown in FIG. 1 is an example configuration, which was chosen purely for the sake of conceptual clarity. In alternative embodiments, any other suitable configurations can also be used.

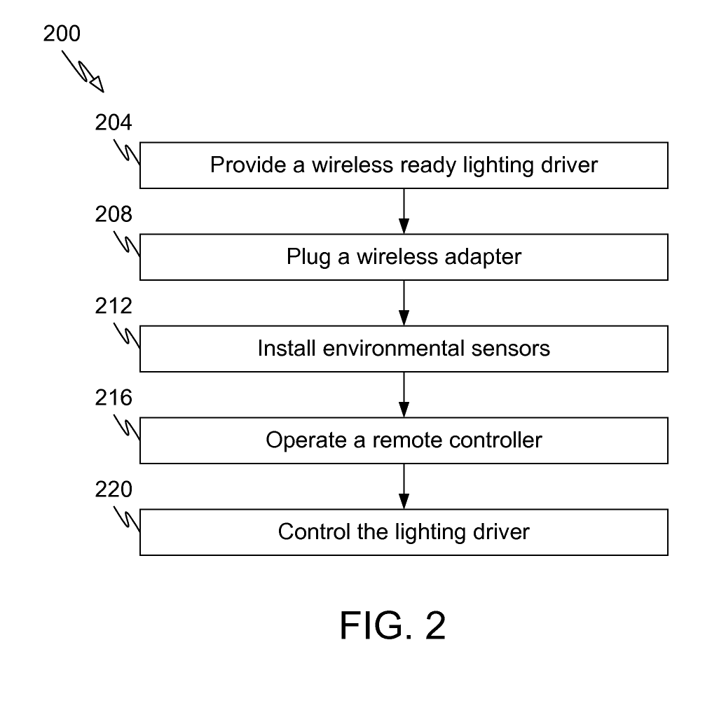

FIG. 2 shows a flowchart 200 which schematically illustrates a method for controlling LED driver 100, in accordance with an embodiment of the present invention. The method begins with a providing step 204, in which LED driver 104 is provided, wherein the LED driver is wireless ready by virtue of interface port 124. In a plugging step 208 that follows, wireless adapter 128 is plugged into interface port 124 for enabling the wireless readiness of LED driver 104. Next, in an installing step 212, environmental sensors 140 are installed for sensing environmental conditions in the vicinity of LED chain 112. In an operating step 216, a user, not shown in FIG. 1, may control LED driver 104 by means of remote controller 134, optionally a smartphone as explained above. Flowchart 200 ends with a control step 220, in which control unit 120 controls driving unit 116 based on control data received from remote controller 134 and/or environmental sensors 140 through wireless connectivity 138, wireless adaptor 128 and interface port 124.

Flowchart 200 is an example flowchart, which was chosen purely for the sake of conceptual clarity. In alternative embodiments, any other suitable flowchart can also be used for illustrating the disclosed method. Method steps that are not mandatory for understanding the disclosed techniques were omitted from FIG. 2 for the sake of simplicity.

Although the embodiments described herein mainly address lighting systems, the methods and systems exemplified by these embodiments can also be used for other controlled systems.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A lighting driver comprising:
a driving unit configured to receive AC power through an AC power line;
a control unit coupled to the driving unit and configured to affect the driving unit operation; and
an interface port coupled to the control unit and adapted to accept a wireless adapter, thereby allowing remote control of the driving unit operation through the wireless adapter and the control unit.

2. The lighting driver of claim 1, wherein the remote control of the driving unit operation comprises messages the wireless adapter transfers to the control unit.

3. The lighting driver of claim 1, wherein the remote control of the driving unit operation comprises electrical levels that the wireless adapter transfers to the control unit.

4. The lighting driver of claim 1, wherein the control unit is further configured to manage the wireless adapter when the wireless adapter is plugged into the interface port.

5. The lighting driver of claim 1, wherein the control unit is configured, upon receiving an AC power through a phase cut dimmer, to control the driving unit respectively to the phase cut dimmer dimming angle.

6. The lighting driver of claim 1, wherein the driving unit is adapted to drive one or more light emitting diodes (LEDs).

7. The lighting driver of claim 1, wherein the remote control of the driving unit operation comprises monitoring of the driving unit operation.

8. The lighting driver of claim 1, wherein the remote control of the driving unit operation comprises remote control of at least one of lighting intensity, lighting color and lighting blinking rate.

9. The lighting driver of claim 1, wherein the wireless adapter supports at least one of Bluetooth, ZigBee and Wi-Fi wireless protocols.

10. The lighting driver of claim 1, wherein the interface port comprises Universal Serial Bus (USB).

11. The lighting driver of claim 1, wherein the remote control of the driving unit operation comprises a control application installed in a remote controller.

12. The lighting driver of claim 11, wherein the remote controller comprises a smartphone.

13. The lighting driver of claim 1, wherein the remote control of the driving unit operation comprises data communication between environmental sensors and the wireless adapter.

14. A method comprising the step of providing a lighting driver that comprises an interface port adapted to accept a wireless adapter, thereby allowing wireless remote control of the lighting driver when there is a wireless adapter plugged into the interface port.

15. The method of claim 14, wherein the wireless remote control of the lighting driver comprises transferring messages between the wireless adapter and the lighting driver.

16. The method of claim 14, wherein the wireless remote control of the lighting driver comprises transferring electrical levels between the wireless adapter and the lighting driver.

17. The method of claim 14, further comprising managing the wireless adapter by the lighting driver when the wireless adapter is plugged into the interface port.

18. The method of claim 14, wherein the lighting driver is configured, upon receiving an AC power affected by a phase cut dimmer having a certain dimming angle, to determine an output power thereof responsively to the certain dimming angle.

19. The method of claim 14, wherein the lighting driver is adapted to drive one or more light emitting diodes (LEDs).

20. The method of claim 14, wherein the wireless remote control of the lighting driver comprises monitoring one or more lighting parameters of the lighting driver.

21. The method of claim 14, wherein the wireless remote control of the lighting driver comprises controlling at least one of lighting intensity, lighting color and lighting blinking rate.

22. The method of claim 14, wherein the wireless remote control of the lighting driver comprises at least one of Bluetooth, ZigBee and Wi-Fi wireless protocols.

23. The method of claim 14, wherein the interface port comprises Universal Serial Bus (USB).

24. The method of claim 14, wherein the wireless remote control of the lighting driver comprises operating a control application installed in a remote controller.

25. The method of claim 24, wherein the remote controller comprises a smartphone.

26. The method of claim 14, wherein the wireless remote control of the lighting driver comprises transmitting environmental data from one or more environmental sensors to the lighting driver through the wireless adapter.

27. A lighting system comprising:
a lighting driver comprising an interface port adapted to accept a wireless adapter; and
a wireless adapter plugged into the interface port, to allow wireless remote control of the lighting driver.
